(19) United States
(12) Patent Application Publication
(10) Pub. No.: US 2014/0121097 A1
(43) Pub. Date: May 1, 2014

(54) CATALYSTS BY CONCURRENT CREATION OF SUPPORT AND METAL (3C-SAM)

(71) Applicant: The Materials Foundry, LLC, Greenwich, CT (US)

(72) Inventors: Jonathan Phillips, Pacific Grove, CA (US); Brian James Scanlan, Greenwich, CT (US)

(73) Assignee: The Materials Foundry, LLC, Greenwich, CT (US)

(21) Appl. No.: 14/034,870

(22) Filed: Sep. 24, 2013

Related U.S. Application Data
(60) Provisional application No. 61/705,503, filed on Sep. 25, 2012.

(51) Int. Cl. B01J 27/22; B01J 23/42

(52) U.S. Cl. CPC B01J 27/22; B01J 23/42
USPC 502/177; 502/300; 502/325; 502/334

(57) ABSTRACT

A catalyst structure comprising dispersed metal catalyst on support, wherein the support but not the metal catalyst can be observed using x-ray diffraction, and wherein the metal catalyst can be chemically detected.

### CROSS REFERENCE TO RELATED PATENT APPLICATION

This application claims the benefit of U.S. Provisional Application No. 61/705,503, filed Sep. 25, 2012, hereby incorporated by reference in its entirety.

### FIELD

The present invention is directed to catalysts and specifically to supported metal catalysts and methods of making supported metal catalysts.

### BACKGROUND

For nearly a century the vast majority, i.e. more than 90% by value, of commercially generated supported metal catalysts have been made using ‘wet impregnation’, in particular a variant of that process referred to as incipient wetness (IW). The incipient wetness process fundamentally includes: i) dissolving a compound of the catalytic metal (e.g. PtCl), or compounds of several different catalytic metals, in water, ii) impregnating, until the point of ‘incipient wetness’ (just visibly wet) a high surface area ceramic, generally a form of alumina, with this solution, iii) drying the mixture of support and dissolved metal compound and iv) calcining at a temperature (ca. 350° C.) that will decompose the compound. In some cases additional steps, such as reducing in hydrogen at an elevated temperature may be needed. Some variant of this simple process is currently used to make virtually all catalytic converters used in vehicles, many catalysts used in petroleum refining, etc.

### SUMMARY

An embodiment is drawn to a catalyst structure comprising dispersed metal catalyst on support, wherein the support but not the metal catalyst can be observed using x-ray diffraction, and wherein the metal catalyst can be chemically detected.

Another embodiment is drawn to a process of making a catalyst structure including combining a compound that decomposes to yield gaseous reducing species, a catalytic metal precursor compound, and a catalyst support precursor compound and heating the combined compounds to form the catalyst structure comprising dispersed metal catalyst on the support in a same step.

### BRIEF DESCRIPTION OF THE DRAWINGS

FIG. 1 is an X-ray diffraction (XRD) spectrum of an embodiment having 5 wt % Pt catalyst.

FIGS. 2A and 2B are a high angle annular dark field (HAADF) scanning transmission electron microscope (STEM) images of an embodiment having 5 wt % Pt on a support.

FIG. 3 is a plot of the catalytic activity as a function of cycles of an embodiment and comparative catalysts illustrating the relative stabilities of the catalysts.

### DETAILED DESCRIPTION

Embodiments include both novel processes for creating a new form of supported metal catalysts and new forms of material that include metal catalysts. The material can broadly be categorized as a ‘supported metal catalyst’. Features of its morphology, such as its apparently perfect dispersion of the metal as ‘rafts’ and improved stability during electrolytic cycling suggest that the material is fundamentally different from any reported supported metal catalysts. The novelty of the process includes both the nature of the ingredients used as well as the process employed to convert the ingredients into a ‘supported metal catalyst’. In an embodiment, the ingredients include a metal compound (e.g., aluminum nitrate hydrate) of the targeted ‘support’ material, a compound of the targeted catalytic metal (e.g. tetraamineplatinumnitrate) and a compound that thermally decomposes to create reducing gases (e.g. urea or ammonium nitrate or other species that decomposes to create reducing gases). In an embodiment, the process includes physically mixing these ingredients and heating the mixture in an inert atmosphere (e.g. N₂, Ar₂, He₂, etc.) to a temperature above the decomposition temperature of the compound that releases reducing gases upon decomposition.

Only a very limited effort has been directed toward to creating supported metal catalysts using techniques other than incipient wetness. Among the reasons for this are that incipient wetness is: i) inexpensive, ii) well tuned, iii) flexible, iv) yields catalysts of high metal dispersion and v) there is sufficient installed capacity to meet demand. Attention has been focused on tuning the IW process and finding the least expensive but catalytically acceptable mixtures of metals (generally precious group metals) to meet given specifications.

An evaluation of earlier efforts at finding alternatives to IW indicates that on a technical basis there were both successes and failures. However, even the technical successes have yet to make a significant impact on the market. One example alternative method includes the thermal decomposition of metal carbonyls over high surfaced area supports. It was postulated that catalysts made in this fashion would have unique ‘sites’ reflective of the structure of the metal in the carbonyl molecule. The notion was to ‘heterogenize’ a homogeneous catalytic species. However, it was found that the carbonyl molecules linked to the supports via oxidizing surface groups, requiring a high temperature reduction step to activate the metal. This in turn led to restructuring and sintering of the metal moieties on the surface. The net result was that no special sites could be created on conventional supports and once activated, there was no evidence of superior dispersion.

A more recent, and more promising route, is the use of the Aerosol-Through-Plasma (A-T-P) method for the production of supported metal catalysts. Recent reports suggest that catalysts made using a plasma method are more stable over time than those prepared using standard methods such as incipient wetness. This may have practical benefits. For example, the loading on three way catalysts reflects the sintering that takes place during use. Due to sintering, the activity of catalysts prepared using standard techniques decreases with time. For example, the decline in the activity of three-way auto exhaust catalysts can be directly correlated with precious metal particles sintering and the concomitant loss of active catalytic surface area during prolonged use at ca. 650° C.

Standard three-way catalysts are ‘engineered’ to meet the 100,000 mile specifications by ‘overloading’ the fresh catalyst with precious metal. Thus, even after considerable sintering/catalytic surface area reduction and activity loss, it still meets the legal activity requirements at all times. In contrast, A-T-P generated catalysts show little activity loss/sintering with use. There typically is no need to overload the fresh catalyst with platinum group metals. Hence, far less metal is required to meet the 100,000 mile specification.

The embodiments of the present invention are drawn to an alternative method to incipient wetness production of supported metal particles. Unlike other alternative processes, the entire catalyst (i.e. both support and metal) is made in a single step by the thermal decomposition of a dry physical mixture of compounds. In prior art processes, the support phase is pre-made and the metal is then added. The process of the embodiments of the invention can be carried out either as a batch process or a dry aerosol process. Additionally, the metal dispersion achieved and the morphology of the catalytic metal dispersed is found to be ‘non-diffracting’ as discussed in more detail below. Evidence indicates that the catalytic atoms are in structures so dispersed that no XRD can be collected. Although x-ray diffraction is not able to demonstrate the presence of the catalytic metal, chemical analysis, such as x-ray flouresence, can be used to demonstrate the presence of the catalytic metal. Other techniques, such as high angle annular dark field (HAADF) STEM, or chemical gas adsorption, produce data that are consistent with the postulate that the metal is present only as small clusters or two-dimensional rafts (e.g., nano-rafts). That is, ‘flat’ metal structures with only a single atom in thickness.

Initial tests show that catalysts made by the methods below are more active and more stable through thousands of electrolytic cycles than incipient wetness catalysts for electrochemical catalysis.

Embodiments also include catalysts structures made by the methods described above. These catalyst structures include a dispersed metal catalyst on a support, wherein the support but not the metal catalyst can be observed using x-ray diffraction and wherein the metal catalyst can be chemically detected. The metal catalyst may be between 0.5 and 50 weight percent of the structure, such as 1-25 weight percent. In an embodiment, the metal catalyst comprises 3-20 weight percent of the structure and the support comprises 80-97 weight percent of the structure. In another embodiment, the metal catalyst comprises 5-10 weight percent of the structure.

In an embodiment, the catalyst comprises at least one noble metal or transition metal and the support comprises carbon, metal carbide, metal oxide or metal nitride. In an embodiment, at least 90%, such as 90-100%, for example 95-99% of the dispersed metal catalyst comprises dispersed metal clusters each having 10 atoms or less, such as 6 atoms or less. In an embodiment, the metal catalyst comprises platinum, the support comprises molybdenum carbide and the chemical detection comprises x-ray fluorescence.

An embodiment includes a process of making a catalyst structure that includes combining a compound that decomposes to yield gaseous reducing species, a catalytic metal precursor compound, and a catalyst support precursor compound and heating the combined compounds to form the catalyst structure comprising dispersed metal catalyst on the support in a same step. In an embodiment, the support but not the metal catalyst can be observed using x-ray diffraction and the metal catalyst can be chemically detected. In another embodiment, the compound which decomposes comprises urea, the metal precursor compound comprises a noble metal or transition metal organic compound and the catalyst support precursor compound comprises a compound that creates a thermally stable, high surface area ceramic support when thermally decomposed. The catalytic metal precursor may include nitrites, oxides, hydroxides, amines, carbonyls, metal organic compounds or a halogen complex. In an embodiment, the step of heating is conducted at a temperature greater than a thermal decomposition temperature of urea. In another embodiment, the step of combining includes mixing the compounds and the step of heating includes heating the mixture or heating an aerosol of the mixture in a carrier gas stream.

An embodiment includes a process for making supported metal catalysts having less than 50 wt % catalytic metal including: a) creating a physical mixture including: i) a compound that decomposes to yield gaseous reducing species, ii) a catalytic metal precursor compound and iii) a compound that when thermally decomposed creates a thermally stable high surface area ceramic. This embodiment also includes the steps of b) heating mixture in an inert gas atmosphere to a temperature greater than a thermal decomposition temperature of the compound that decomposes to yield gaseous reducing species and c) heating for a sufficient period of time for the supported metal catalyst to fully form from the compounds in the mixture. In an embodiment, the inert gas atmosphere includes (nitrogen, argon, helium, or a combination thereof. In another embodiment, the catalytic metal precursor compound includes a nitrate, amine, acetate, carbonyl or halogen complex containing one or more transition metal or platinum group metal atoms.

In an embodiment, the compound that thermally decomposes to create a thermally stable high surface area ceramic includes a transition metal nitrate, aluminum nitrate, ammonia complex, or halogen complex. In an embodiment, the stable high surface area ceramic is an oxide, a carbide, a nitride or a combination thereof. In another embodiment, the sufficient period of time is greater than 1 second and less than 90 minutes, such as less than 30 minutes, including 200 to 600 seconds. In an embodiment, the process includes a plurality of catalytic metal precursor compounds in the physical mixture. In another embodiment, the catalytic metal complex includes one or more of platinum, palladium, rhodium, iridium, ruthenium of osmium. In an embodiment, the ceramic precursor compound includes aluminum, silicon, titanium, magnesium or combinations thereof.

Another embodiment includes an aerosol process for making supported metal catalysts having less than 50 wt % catalytic metal including: a) creating a physical mixture including: i) a compound that decomposes to yield gaseous reducing species, ii) a catalytic metal precursor compound and iii) a compound that when thermally decomposed creates a thermally stable high surface area ceramic. This embodiment also includes the steps of b) creating a gas/solid aerosol of the above mixture and an inert gas, c) passing the aerosol through a high temperature zone having a temperature above the decomposition temperature of the compound that decomposes to yield the gaseous reducing species and d) heating for sufficient time in the high temperature zone for the catalyst to fully form from the mixture. In an embodiment, the catalytic metal precursor compound includes a nitrate, amine, acetate, carbonyl or halogen complex containing one or more transition metal or platinum group metal atoms. In another embodiment, the compound that thermally decomposes to create a thermally stable high surface area ceramic is a transition metal nitrate, aluminum nitrate, a metal containing ammonia complex or a halogen complex that contains metal atoms.

In an embodiment, the sufficient period of time is greater than 0.01 second and less than 300 seconds. In another embodiment the process includes a plurality of catalytic metal precursor compounds in the physical mixture. In an embodiment, the catalytic metal complex includes one or more of platinum, palladium, rhodium, iridium, ruthenium of osmium. In an embodiment, the ceramic precursor compound includes aluminum, silicon, titanium, magnesium or combinations thereof.

Another embodiment includes a process of: a) creating a mixture including three types of compounds: i) urea, or other compound, for example ammonia nitrate, that upon thermal decomposition yields gaseous reducing species, ii) a catalytic metal precursor compound in which the metal(s) in the compound is (are) from the platinum group metals and iii) a compound that when thermally decomposed creates a thermally stable high surface area ceramic, in which the precursor is a compound which upon heating in air forms a metal oxide, metal carbide or metal nitride. The metal of this compound is preferably not from the precious metal group. This embodiment also includes the steps of b) heating these compounds in a batch, preferably in an inert gas (nitrogen, argon, helium etc.) environment, to a temperature greater than the thermal decomposition temperature of urea, or other species that decomposes to yield reducing gas species and c) heating for a sufficient time to thermally decompose all of the parent compounds.

An embodiment includes a batch process for creating Pt/Al₂O₃ catalysts for three way catalysts suitable for petroleum refining operations, etc. Pt/γAl₂O₃ is a standard ‘vanilla’ catalyst used in petroleum refining, hydrocarbon isomerization, etc. Standard 3-way catalysts for automotive catalytic converters are variations on this composition. For example, a 2Pt/1Pd 5 wt % total metal on Pt/γAl₂O₃ is a standard 3-way catalyst composition.

In one embodiment, a method of making a 1 gram 0.5 wt % Pt/Al₂O₃ catalyst from compounds includes the following steps.
Step 1: Mix thoroughly 0.02 gms of tetraamineplatinum nitrate with 0.12 gms of urea.
Step 2: Add 14.7 gms of aluminum nitrate nonahydrate to the mixture created in Step 1 and mix well again.
Step 3: Place the mixture in an alumina boat.
Step 4: Place boat in center of quartz tube. Flush thoroughly with nitrogen gas.
Step 5. Preheat tube furnace to ˜775 C. Put quartz tube in the furnace such that the alumina boat is in the center of the heated zone.
Step 6: Remove quartz tube from furnace, after a sufficient time, such as 200-600 seconds. Allow to thoroughly cool in flowing nitrogen before removing alumina boat, now containing ˜2 gms of 0.5 wt % Pt/Al₂O₃ catalyst.

In this embodiment, the initial ingredients are all molecular compounds. No refractory oxide support is present initially and the alumina support is formed at the same time as the catalyst from the precursor compounds. This distinguishes this process from prior art supported metal catalyst syntheses.

Another embodiment includes an aerosol process for creating Pt/Al₂O₃ catalysts for 3 way auto exhaust catalysts, petroleum refining operations, etc.

In this aerosol synthesis, Steps 1 and 2 are identical to those described in the embodiment above. However, the heating steps (Steps 3 through Step 6) are different. In this embodiment, the heating of the mixture created in Steps 1 and 2 is by aerosol passage through a hot zone. Specifically, after completing the first two steps, this embodiment includes a third step, Step 3, which includes creating an aerosol (by mechanical agitation, and/or high velocity gas impingement, etc.) of the powder mix created in Steps 1 and 2 and inert carrier such as nitrogen. The solid powder volume fraction will in most cases be very low (e.g. <1%). After Step 3, a fourth step, Step 4, is performed. Step 4 includes directing the aerosol through a hot zone of a preheated furnace. The furnace temperature (such as 800-1200° C., such as 1000° C.) is hotter than that used in the batch process described in Example 3 above. Preferably, the only gas present in the aerosol is an inert gas such as nitrogen, argon or helium or mixtures thereof.

One embodiment includes a batch production of 5 wt % Pt/Mo₂C catalysts for fuel cell applications.

Fuel cells generally employ catalysts consisting of Pt (ca. 20 wt %) on support materials with moderate conductivity. In particular, commercial fuel cells typically use a moderate amount of Pt (ca 20 wt %) on a variety of high surface area (>100 m²/gm) conductive carbons.

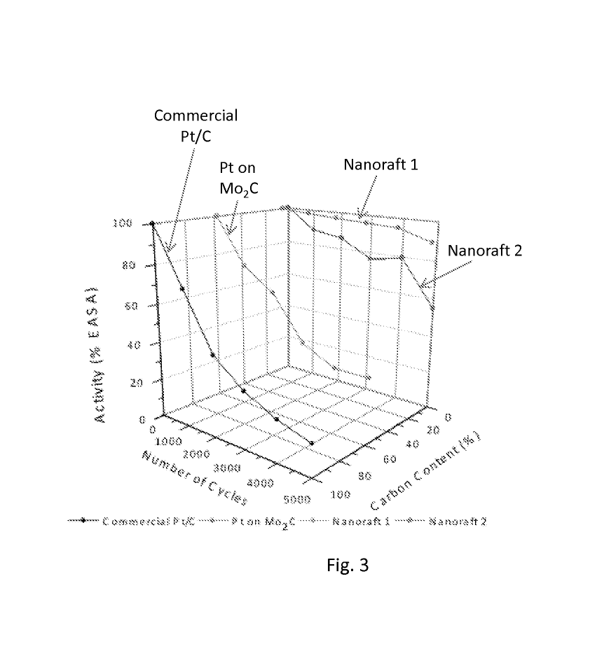

Catalysts prepared according to the methods describe below include sufficient components for use as a fuel cell catalyst. That is, they include a catalyst metal (e.g. Pt) on a support, such as a conductive support. In an embodiment, the catalyst includes Pt on a molybdenum carbide support (labeled as samples “Nanoraft 1”, “Nanoraft 2” in FIG. 3). FIG. 3 also illustrates commercial Pt/C catalyst and Pt/Mo₂C catalyst made using a different method. In an example, the catalyst includes ˜5 wt % Pt on a Mo₂C support. This catalyst demonstrated a higher activity, remarkable Pt dispersion and was far more stable than commercial fuel cell catalysts.

PREPARATION—In an embodiment, to make 1.0 gms of a 5 wt % Pt/Mo₂C catalyst, the following weights of three reagents (obtained from Sigma Aldrich, >99% purity) were combined: 0.1 gms of tetraamineplatinumnitrate ((NH₃)₄Pt(NO₃)₂), 0.6 gms of urea and 1.78 gms of ammonia molybdate (NH₄)₆Mo₇O₂₄4H₂O).

For testing purposes, several batches, using precisely the above ratios of reagents were made. A first step includes mixing the reagents. In an embodiment, mixing is done in two stages. Mixing may be accomplished with, for example, a small metal blender (e.g. volume ˜200 cc). First, the tetramineplatinumnitrate and urea may be blended for 5-30 seconds, such as 10 seconds and the homogenized mixture left in the blender. Second, ammonia molybdate may be added to the mixture in the blender and this mixture mixed for 10-60 seconds, such as 30 seconds. The three component (urea, teraamineplatinumnitrate and ammonia molybdate) homogenized mixture created by the mixing process may be placed in an alumina boat, such as ˜20 cc alumina boat. The boat may be put into a furnace or oven, such as a tube furnace. In an embedment, the boat is placed inside a quartz tube which is inserted in a furnace. Preferably, the furnace is continuously flushed with an inert gas, such as nitrogen gas (e.g. >8 flushes by volume). Once the flushing is judged to have removed of the order of 95-99.9%, such as 99% of the oxygen originally present, the furnace may be continuously flushed with nitrogen. Continuous flushing may be done at a slower rate (such as with an estimated gas velocity of 0.1 cm/sec). The boat may then be placed inside the furnace, or inside a tube which is placed inside a furnace. Preferably, the furnace is pre-heated to a temperature of 600-1200° C., such as, 700-1000° C., such as 800° C. After a suitable amount of time, such as 200-600 seconds, such as 300-500 seconds, the boat may be removed from the furnace and the nitrogen flow rate increased. After the boat is thoroughly cooled, the material in the alumina boat may be removed for characterization and catalyst testing.

### Characterization

Composition—In an example, the weight loading Pt was measured using x-ray fluorescence and found to be 5.6 wt %. This is nearly identical from the weight percent predicted assuming that only the Pt and Mo atoms in the original mixture would not volatilize and that only enough carbon remained in the sample to create Mo₂C.

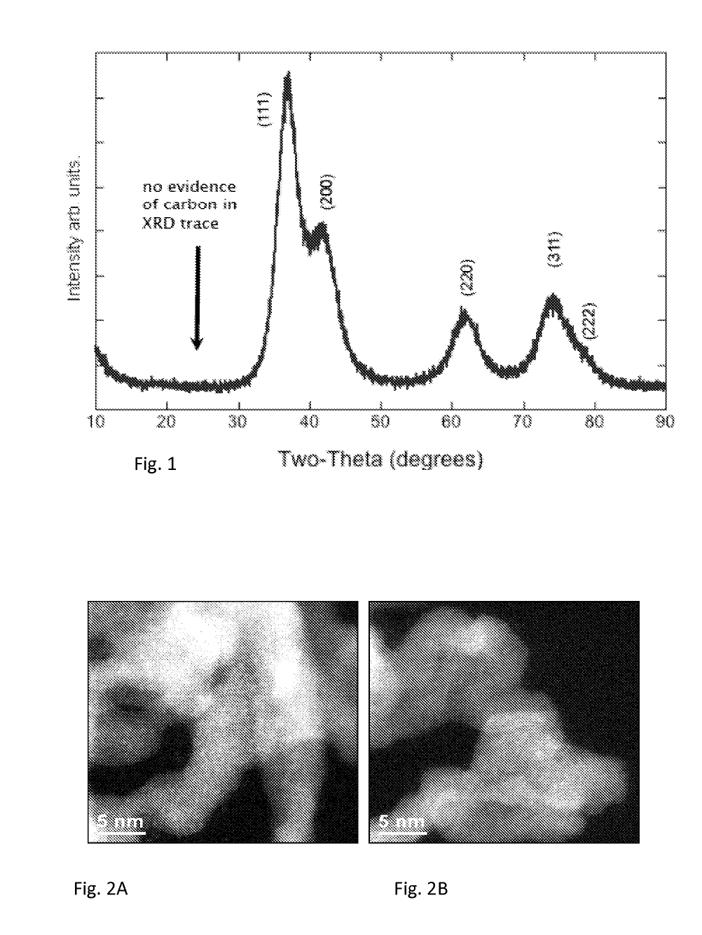

Morphology—The structure of the material was studied using x-ray diffraction (XRD), transmission electron microscopy (TEM) and Scanning Transmission Electron Microscopy (STEM). X-ray diffraction confirmed that the only crystalline phase was Mo₂C. Unexpectedly, no lines belonging to platinum were present, as illustrated in the XRD spectra in FIG. 1. The only diffracting phase is Mo₂C. Remarkably, no Pt diffraction lines are present in a material that is 5.6 weight % Pt. Platinum is a high Z material and generally produces high intensity XRD lines. The lack of platinum XRD lines is a clear demonstration that the material produced with the method described above is a new form of matter. Further, unlike other Mo based support materials, there is no apparent free carbon.

Transmission electron microscope (TEM) results were consistent with the XRD results. Specifically, the TEM results failed to reveal any indication of the existence of ‘particles’. Platinum structures were located only by using high angle annular dark field (HAADF) scanning transmission electron microscopy (STEM) as illustrated in FIGS. 2A, 2B. Specifically, very small platinum ‘rafts’ including ten or less, such as six or less atoms, such as 3-10, such as 3-6 atoms were found distributed over the entire surface of the catalyst. In one embodiment, the nanoraft is one atom thick. It is believed that these structures are too small to create a measurable diffraction.

Catalytic Performance/Stability—Using a standard half cell electrolytic reaction (the catalysis of the oxygen reduction reaction (ORR) of water/peroxide) the activity of the catalyst was measured with a rotating ring-disk electrode. The activity was found to be 70 A/mg Pt at 0.9V vs. a reversible hydrogen electrode (RHE—reference electrode). In contrast, the activity measured for a fresh commercial ETEK electrode with 20% Pt on it is 40 A/mg Pt. Hence, an embodiment of the catalyst has nearly twice the activity of fresh commercial Pt on carbon. The nanorafts also have a better wave potential (0.92V vs. 0.89V for the commercial catalyst) and onset (1.04V vs. 1.11V).

Improvement in catalytic activity is not the only difference between the catalysts of the embodiments of the invention and the commercial catalyst. As reflected in FIG. 3, the catalyst made by the above described method (Nanoraft 1, Nanoraft 2) was far more stable over thousands of electrolytic cycles including a standard commercial Pt/C and a 20 wt % Pt on a Mo₂C support generated by an alternative technology. The catalyst lost very little (less than 10%, such as approximately 5%) of its activity over nearly 5000 cycles. In contrast, the best commercial catalyst was essentially completely deactivated after only four thousand cycles. Additionally, it is notable that even after 5000 cycles no Pt reflections were found in the present catalysts using XRD. This is consistent with the measured catalytic stability. That is, the XRD result strongly suggests that the original platinum morphology demonstrated in FIG. 1 is unchanged after a ‘stiff’ test of electrolytic stability. In comparison, it is well known that with the conventional Pt/carbon catalyst (e.g. the standard commercial fuel cell catalysts), Pt metal sintering is dramatic (as reflected in activity loss) after stability tests, such as that employed in FIG. 3.

A second embodiment includes aerosol production of 5 wt % Pt/Mo₂C catalysts which may be used in fuel cell applications.

The process for making the mixture of components required for the 5 wt % Pt/Mo₂C is identical to that described in embodiment above. However, the heating process is different. In this embodiment, the powder mixture of urea, teraamineplatinumnitrate and ammonia molybdate is not heated as a ‘batch’ in a tube furnace. Rather, the mixture is passed as an aerosol through a heated zone held at a temperature greater than the decomposition temperature of urea using an inert carrier gas such as nitrogen or argon.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

1. A catalyst structure comprising dispersed metal catalyst on support, wherein the support but not the metal catalyst can be observed using x-ray diffraction, and wherein the metal catalyst can be chemically detected.

2. The structure of claim 1, wherein the metal catalyst comprises between 1 and 50 weight percent of the structure.

3. The structure of claim 2, wherein the metal catalyst comprises 3-20 weight percent of the structure and the support comprises 80-97 weight percent of the structure.

4. The structure of claim 3, wherein the metal catalyst comprises 5-10 weight percent of the structure.

5. The structure of claim 1, wherein the catalyst comprises at least one noble metal or transition metal, and the support comprises carbon, metal carbide, metal oxide or metal nitride.

6. The structure of claim 1, wherein at least 90% of the dispersed metal catalyst comprises dispersed metal clusters each having 10 atoms or less.

7. The structure of claim 7, wherein 90-100% of the dispersed metal catalyst comprises dispersed metal clusters each having 6 atoms or less.

8. The structure of claim 7, wherein the metal catalyst comprises platinum, the support comprises molybdenum carbide and the chemical detection comprises x-ray fluorescence.

9. The structure of claim 7, wherein the metal catalyst clusters produce substantially no diffraction and are detectable by STEM high angle annular dark field (HAADF) mode, and wherein the metal catalyst does not comprise metal nanoparticles which can be detected by TEM.

10-11. (canceled)

12. A process of making a catalyst structure, comprising:
combining a compound that decomposes to yield gaseous reducing species, a catalytic metal precursor compound, and a catalyst support precursor compound, and
heating the combined compounds to form the catalyst structure comprising dispersed metal catalyst on the support in a same step.

13. The process of claim 12, wherein the support but not the metal catalyst can be observed using x-ray diffraction, and wherein the metal catalyst can be chemically detected.

14. The process of claim 12, wherein the compound which decomposes comprises urea, the metal precursor compound comprises a noble metal or transition metal organic compound and the catalyst support precursor compound comprises a compound that creates a thermally stable, high surface area ceramic support when thermally decomposed.

15. The process of claim 14, wherein the step of heating is conducted at a temperature greater than a thermal decomposition temperature of urea.

16. The process of claim 12, wherein the step of combining comprises mixing the compounds and the step of heating comprises heating the mixture or heating an aerosol of the mixture in a carrier gas stream.

17. A process for making supported metal catalysts having less than 50 wt % catalytic metal, comprising:
a) creating a physical mixture comprising:
i) a compound that decomposes to yield gaseous reducing species;
ii) a catalytic metal precursor compound; and
iii) a compound that when thermally decomposed creates a thermally stable high surface area ceramic;
b) heating mixture in an inert gas atmosphere to a temperature greater than a thermal decomposition temperature of the compound that decomposes to yield gaseous reducing species; and
c) heating for a sufficient period of time for the supported metal catalyst to fully form from the compounds in the mixture.

18. The process of claim 17, wherein the inert gas atmosphere comprises nitrogen, argon, helium, or a combination thereof.

19. The process of claim 17, wherein the catalytic metal precursor compound comprises a nitrate, amine, acetate, carbonyl or halogen complex containing one or more transition metal or platinum group metal atoms.

20. The process of claim 17, wherein the compound that thermally decomposes to create a thermally stable high surface area ceramic comprises a transition metal nitrate, aluminum nitrate, ammonia complex, or halogen complex.

21. The process of claim 17, wherein the stable high surface area ceramic is an oxide, a carbide, a nitride or a combination thereof.

22. The process of claim 17, wherein the sufficient period of time is greater than 1 second and less than 30 minutes;
wherein the catalytic metal complex comprises one or more of platinum, palladium, rhodium, iridium, ruthenium of osmium; and
wherein the ceramic precursor compound comprises aluminum, silicon, titanium, magnesium, or combinations thereof.

23-32. (canceled)
